(19) United States
(12) Patent Application Publication
(10) Pub. No.: US 2018/0118407 A1
(43) Pub. Date: May 3, 2018

(54) CLOSING AND OPENING SYSTEMS, AND TEAR TAPE OPENING SYSTEMS

(71) Applicant: H.B. Fuller Company, St. Paul, MN (US)

(72) Inventors: Jorge A. Nash, Vancouver, WA (US); William W. Maness, Vancouver, WA (US); Cynthia A. Stewart-Irvin, Vancouver, WA (US); Asuka Westbrook, Vancouver, WA (US); Justine Hanlon, Vancouver, WA (US); Peter Lockey, Vancouver, WA (US)

(21) Appl. No.: 15/794,923

(22) Filed: Oct. 26, 2017

Related U.S. Application Data
(60) Provisional application No. 62/414,392, filed on Oct. 28, 2016.

(51) Int. Cl. B65D 17/50; C09J 7/02; B32B 3/28; B32B 7/12; B32B 27/10; B31B 50/62

(52) U.S. Cl. CPC B65D 17/502; C09J 7/0275; C09J 7/0246; B32B 3/28; B32B 7/12; B32B 27/10; B32B 2439/00; C09J 2201/606; C09J 2201/61; C09J 2201/40; C09J 2201/28; C09J 2423/106; B31B 50/62

(57) ABSTRACT

Disclosed herein are tape opening systems, containers, and methods to produce display-ready containers formed of paper-based substrates. The clean tear openings of the disclosed containers are accomplished through novel incorporations of monoaxiaily oriented films with directional tear properties. Also disclosed are closure and opening systems for multi-wall and polywoven pinch bottom open mouth bags using same monoaxially tearable films.

### CROSS-REFERENCE TO RELATED APPLICATIONS

This application claims priority to U.S. Provisional Patent Application No. 62/414,392, filed Oct. 28, 2016, which is incorporated by reference herein in its entirety.

### FIELD

This disclosure is related to tear tapes and packaging materials and containers include tear tape opening systems.

### BACKGROUND

Many consumer items today are packaged by manufacturers for purposes of transportation and shipment to retailers who thereafter remove the items from the container and place them on display in the retail outlet on counters or shelves for the convenience of the consumer. For the most part, such items are packaged in materials such as Kraft paper or corrugated board depending on the strength required by the container. In many cases, and particularly with Kraft paper packaging material, no opening feature is provided for the container so that, in order to remove the contents thereof, it is necessary to dismantle the container, which may result in its destruction.

In some situations, such as containers formed with corrugated board packaging material, an opening feature in the form of score lines which define the desired opening are provided. However, such an opening feature are oftentimes inadequate for display-ready containers since the tear resulting from these opening features fails to open or is uneven destroying the container itself making them unsuitable as display-ready. It is also possible to utilize a sharp object, such as a knife, for the purpose of cutting the packaging material along desired lines. This means, however, is dangerous and can result in injury or damage to container and the contents of the container and consequent wastage.

In other situations, pressure sensitive adhesive (PSA) tapes made with thin plastic film substrates are currently available for tear opening of containers, but such tapes do not pull cleanly through paper board substrates, particularly corrugated board substrates making the container inadequate for display-ready. Other situations incorporate two PSA collaborating with each other to accomplish produce a display-ready container, however such opening features are difficult to apply and too complex for display-ready containers.

In yet other situations, such as containers formed with corrugated board packaging material, an opening feature in the form single or dual tape systems formed from directionally oriented fibers to define the desired opening are provided. However, such an opening feature are oftentimes expensive and over engineered for display-ready containers. Single tapes typically do not have sufficient weft strength to produce a longitudinal tear without undesired lateral tearing,

As indicated above, containers formed of Kraft paper, paperboard or corrugated board containing consumer items are opened and the items removed and positioned on shelves or counters at the retail outlet. Opening of the container and the removal (from non-display-ready containers) and display of the consumer items is a labor intensive operation which requires a person to physically perform the necessary operations. A great benefit could, therefore, be derived if the container itself could be utilized at the retail outlet as the display device for the consumer units thereby eliminating much of the labor presently necessary for removing the units from the container for display. However, this is not possible where the container itself is destroyed during the opening process or else, in those situations where an opening feature was provided, this proved to be inadequate or over engineered.

Accordingly, in view of the shortcomings inherent in conventional Kraft paper, paperboard and corrugated containers, there is an opportunity to supply a packaging container that has all the advantages of conventional containers, yet avoids the shortcomings.

Bulk material bags comprising multi-wall paper, poly-laminated or polywoven materials are typically of the “sewn open mouth” type. These type of bags may or may not have side gussets, but in either case one end of the bag is typically sewn closed and the bag shipped to the manufacturer end user empty, in a flattened condition. The user fills the bag with bulk material such as pet food, agricultural commodities, chemicals and the like through the open top, and the open top is then sewn closed by the consumer, resulting in an efficient bag that is generally suitably strong.

While sewn closures on both ends of a sewn mouth bag are common in the industry, such closures have inherent limitations. For example, sewn closures inherently introduce holes in the bag. Holes can be a problem because they present an entry route for insects and contaminants or allow contents to sift out. Insect contamination in bulk bags containing pet food is a notorious problem. Just as well, other contaminants are able to enter the interior of a bag through the holes sewn through the bag in sewn closures. Sifting is a sign of package failure and can result in entire loads of product being rejected if just one bag leaks or sifts product.

A folded-over closure is an option with current sewn open mouth polywoven bags. On woven bags laminated with paper, an additional adhesive is used to secure the pinched end. On film laminated polybags, hot air is used to create the weld. Some bags have an internal resin coating that can help facilitate the internal bond. Pinched end sealing is challenged by getting the right amount of heat to fuse the thicker weld areas and not scorch the middle portion with less layers to fuse. A stepped end could be a possible solution to this problem with raw materials other than polywoven, the stepped open end is an option with polywoven material. The bags are cut with steps and the end is welded more successfully due to more surface area and less thickness variation which reduces scorching/overheating distortions. The problem with the stepped end weld is that there is no current solution to make this easy to open.

It is possible for a user to melt the polywoven material together in a heat band sealer or to bond the closure closed with a tape strip of polywoven material. The shortcoming with this method is that the opening feature is lost.

Other easy openings have been developed. An example pet food bag has a clear packing tape with a red tear tape in the middle. Pull tabs are cut in the middle of the tape closure to allow the red tape to be pulled through the clear tape. This closure method uses a very wide tape and a narrow tape. It is thought that the closure is expensive and not strong enough and therefore has not been implemented widely. Zip openings have also been developed being held in by pressure sensitive labels. Zip openings have proved to be too expensive a solution for the market.

Accordingly, in view of the shortcomings inherent in conventional multi-wall and polywoven bags, there is an opportunity to supply a packaging container that has all the advantages of conventional bags, yet avoids the shortcomings.

### SUMMARY

Various tear tape embodiments are disclosed. Some tear tape embodiments comprise a film layer having a first surface and an opposing second surface, a longitudinal direction and a width direction perpendicular to the longitudinal direction, and comprising monoaxially oriented film that tears along the longitudinal direction of the film layer but is resistant to tear across the width of the tape. The tear tapes also comprise an adhesive layer covering at least a portion of the first surface of the film layer, such that the tear tape is configured to be adhered to a packaging material via the adhesive layer. In some embodiments, the tear tape adhered to a packaging material can provide a clean longitudinal tear of the packaging material along the longitudinal direction of the tear tape while restricting tearing in the width direction of the tear tape. The adhesive layer can comprises pressure sensitive adhesive, hotmelt adhesive, and/or other materials.

In some embodiments, the tear tape further comprises a second adhesive layer covering at least a portion of the second surface of the film layer, such that the tear tape is configured to be adhered between two layers of packaging material via the two adhesive layers. In sonic tape embodiments, a second film or paper layer can also be included, sandwiching one of the adhesive layers.

Also disclosed herein are various packaging materials, including sheet materials, boxes, bags, etc. The packaging materials can comprise any of the disclosed tear tapes and at least one layer of a paper based substrate (single layer, multilayer, corrugated, or otherwise) adhered to the adhesive layer. In some embodiments, the tear tape is situated to produce a clean tear of the paper based substrate along the longitudinal direction of the tear tape. In other embodiments, the tear tape is configured to tear without tearing the paper based substrate, such as when opening a bag where the tape overlaps an openable seam in the bag.

In some embodiments, the tear tape includes two layers of adhesive, one on either side of the film layer, and a first layer of paper based substrate is adhered to the first adhesive layer and a second layer of paper based substrate is adhered to the second adhesive layer. In some such embodiments, the tear tape is imbedded within or adjacent the corrugated core layer of a multi-layered corrugated board material. In some embodiments, this embedded tear tape can act as a guide tape and another film or tear tape can be applied on an outer surface of the board material.

In some embodiments, the adhesive layer comprises two spaced apart adhesive strips with a non-adhesive strip or gap between the two spaced apart adhesive strips, and the film layer is configured to tear such that a middle portion of the film layer overlapping the non-adhesive strip tears apart from two lateral portions of the film layer adhered to the two spaced apart adhesive strips. The middle portion of the film layer can then be torn longitudinally apart from the two lateral portions of the film layer, which remain adhered to the underlying paper based substrates, without actually tearing the paper based substrates. This can expose an openable seam in a bag or box, for example that was sealed closed by the tear tape.

In some embodiments, the tear tape is folded over the ends of two layers of paper based substrate (such as at an opening of a flattened bag), with one of the adhesive strips secured to an outer surface of one of the layers and the other of the adhesive strips secured to an outer surface of the other layer, and with middle portion of the film layer extending over free edges of the two layers, such that tearing the middle portion of the film layer away exposes an opening between the two layers without tearing the paper based substrates.

In some embodiments, the adhesive layer comprises three side-by-side longitudinally extending adhesive strips, including a middle adhesive strip and two lateral adhesive strips. The middle adhesive strip can comprise an adhesive with a lower heat or pressure threshold for adhesion to the paper based substrate relative to the two lateral adhesive strips.

In some embodiments, the packaging material comprises a corrugated layer of paper based substrate, and the tear tape is adhered to or imbedded in the corrugated layer.

Disclosed methods of manufacturing a packaging material comprise first forming a tear tape by applying an adhesive layer to a film layer comprising monoaxially oriented film that tears along a longitudinal direction of the tear tape, and then forming a packaging material by combining the tear tape with one or more layers of paper based substrate at an intended opening location, such that either a clean tear is formable in the packaging material when the tear tape is removed or an openable seam in the packaging material is exposed when a middle portion of the tape is torn away.

In some methods, combining the tear tape with one or more layers of paper based substrate comprises applying an adhesive side of the tear tape to a location that overlaps a seam between two adjacent sheets of paper based substrate, such that tearing the tape away frees the two sheets to separate apart, like the flap of an common envelope.

In some methods, combining the tear tape with one or more layers of paper based substrate comprises applying an adhesive side of the tear tape to a single sheet of paper based substrate, such that tearing the tape away cleanly tears away a strip of the paper based substrate.

In some methods, combining the tear tape with one or more layers of paper based substrate comprises applying the tear tape to a corrugated layer of paper based substrate.

In some methods, combining the tear tape with one or more layers of paper based substrate comprises folding the tear tape over two free edges of two sheets of paper based substrate such that the adhesive side of the tear tape adheres to outer surfaces of both sheets of paper based substrate.

Any of these methods can further comprise tearing the tear tape away from the packaging material to produce a clean tear in the paper based substrate, such as to open the container and/or to form a structure to display products at a point of sale.

### BRIEF DESCRIPTION OF THE DRAWINGS

The description of this applications refers to the accompanying drawings, which are labeled with the following figure numbers.

FIG. 1 is a perspective view of a cross section of one embodiment of the tape disclosed herein. The view of FIG. 1 is from line A-A as shown in FIGS. 3 and 4.

FIG. 2 is a perspective view of a cross section of one embodiment of the tape disclosed herein. The view of FIG. 2 is from line A-A as shown in FIGS. 3 and 4.

FIG. 3 is a perspective view of one embodiment of a tape roll as disclosed herein.

FIG. 4 is a perspective view of one embodiment of the tape disclosed herein.

FIG. 5A is a perspective view of one embodiment of a paper based substrate that is partially torn via a tear tape opening system as disclosed herein.

FIG. 5B is an exploded view of a portion of the paper based substrate shown in FIG, 5A.

FIG. 6 is a prospective view of a cross section of a paper based substrate and a tape as disclosed herein.

FIG. 7 is a side view of a process for making the paper based substrate/tape embodiment of FIG. 6.

FIG. 8 is a perspective view of a cross section of one embodiment of a paper based substrate and a two tape opening system as disclosed herein.

FIG. 9 is a side view of a process for making the paper based substrate/tape embodiment of FIG. 8.

FIG. 10 is a perspective view of a container that includes a tape as disclosed herein.

FIG. 11 is a perspective view of a cross section of a paper based substrate and a tape as disclosed herein.

FIG. 12 is a side view of a process for making the paperboard substrate/tape embodiment of FIG. 11.

FIG. 13 is a perspective view of a cross section of a bag and a tape as disclosed herein where the tape is both a closing and opening tape.

FIG. 14 is a perspective view of another embodiment of a bag and a tape as as disclosed herein where the tape is both a closing and opening tape.

FIG. 15 is a prospective view of a cross section of one embodiment of a paper based substrate and a two tape opening system as disclosed herein.

FIG. 16 is a side view of a process for making the paperboard substrate/tape embodiment of FIG. 15.

FIG. 17 is a tape with a paper or film laminated to the top of the monoaxially oriented film with directional tear.

FIG. 18 is a tape 50 with multiple adhesives striped on the closing side.

FIG. 19 is a bag sealed with the tape where the application method of pinching the bag shut has concentrated heat and or pressure to seal the areas around the gusset so no sifting occurs.

FIG. 20 is a bag with tape 50 extend beyond the edges of the bag with tape ends pinched together (note tear tab not shown in FIG. 20).

FIG. 21 is a bag with tape 50 extend beyond the edges of the bag (note tear tab not shown in FIG. 21).

### DETAILED DESCRIPTION

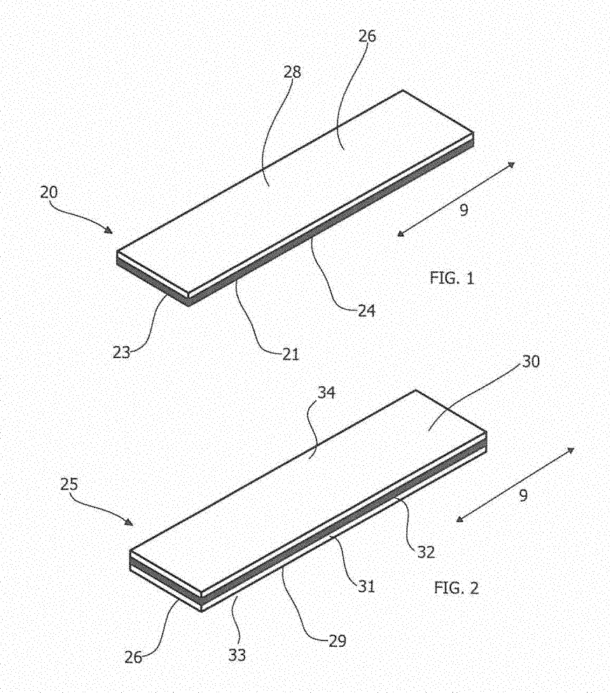

A preferred embodiment of the tear tape 20 disclosed herein is shown in FIG. 1 e The tear tape 20 includes an adhesive (i.e. hot melt or pressure sensitive or adhesive) layer 21 and a directional tear film layer 26. The tear tape has first surface 23 shared by the adhesive and film layer, a second surface 24 defining the outer surface of the adhesive layer of the tape and a third surface 28 defining the outer surface of the film side of the tape. The adhesive 21 may be a layer that covers all, or only a portion thereof, of the area of the first surface 23. The film has both weft strength and the property to tear in the longitudinal direction 9 of the tape 20. In the embodiment of FIG. 1, the film layer 26 provides weft strength to the tear tape and provides a smooth surface for the adhesive layer 21 to bond to.

More information regarding suitable films and adhesives, and methods of making the films, adhesives, and tear tapes, and combining the same with paper based substrates, can be found in U.S. Publication Nos. 2016/0264747 (see, e.g., paragraph 0009) and 2014/0312107; and U.S. Pat. Nos. 8,932,726, 8,986,831, and 8,932,725; all of which are incorporated by reference herein in their entirety.

For illustrative purposes, and as non-limiting examples, films such as those described in U.S. Publication No. 2016/0264747 (see, e.g., paragraph 0009) and U.S. Pat. Nos. 8,932,726 and 8,986,831 can be suitable for use with various embodiments disclosed herein.

Exemplary adhesives that can be used with the disclosed technology can include a hot melt adhesive, a pressure sensitive adhesive, a remoistenable adhesive, a heat activated adhesive, a hot melt pressure sensitive adhesive, a hot melt remoistenable adhesive, a water dispersible hot melt adhesive, a biodegradable hot melt adhesive or a repulpable hot melt adhesive. Examples of these adhesives are any typical hot melt adhesive such as an ethylene-vinyl acetate copolymer (EVA-based) hot melt adhesive; EMA-based hot melt adhesive (ethylene methylacrylate); EnBA-based hot melt adhesive (ethylene n-butyl acrylate); hot melt adhesive based on polyamides; hot melt remoistenable adhesive based on polyamides and copolyesters; hot melt adhesives based on polyethylene and polypropylene homopolymers, copolymers and interpolymers, rubbery block copolymer hot melt adhesives; or RF (radio frequency) activatable adhesives.

Generally, the PSA portion of the tear tape is configured to facilitate secure attachment of the tape to a substrate. The PSA can be a solvent-based adhesive, a water-based adhesive or a hot melt adhesive. Examples of suitable PSA base polymers include rubber pressure-sensitive adhesives containing any of the natural rubbers and synthetic rubbers as a base polymer; acrylic pressure-sensitive adhesives containing, as a base polymer, an acrylic polymer (homopolymer or copolymer) composed of one or more monomer components selected from alkyl esters of (meth)acrylic acids (e.g., alkyl esters whose alkyl moiety having 1 to 20 carbon atoms, such as methyl ester, ethyl ester, propyl ester, isopropyl ester, butyl ester, isobutyl ester, s-butyl ester, t-butyl ester, pentyl ester, hexyl ester, heptyl ester, octyl ester, 2-hydroxyethyl ester, 2-ethylhexyl ester, isooctyl ester, isodecyl ester, dodecyl ester, tridecyl ester, pentadecyl ester, hexadecyl ester, heptadecyl ester, octadecyl ester, nonadecyl ester, and eicosyl ester); vinyl alkyl ether pressure-sensitive adhesives; silicone pressure-sensitive adhesives; polyester pressure-sensitive adhesives; polyamide pressure-sensitive adhesives; urethane pressure-sensitive adhesives; styrenic block copolymer pressure-sensitive adhesives; and pressure-sensitive adhesives having improved creep properties and corresponding to these pressure-sensitive adhesives, except for further containing a tackifying resin having a melting point of about 200 C or below.

In certain embodiments, the pressure sensitive adhesive is a hot melt pressure sensitive adhesive that includes a styrenic block copolymer as the base polymer. Suitable styrenic block copolymers include those having end-blocks of styrene and a rubbery mid-block of butadiene, isoprene, ethylene/propylene, ethytene/butylene and combinations thereof. Styrenic block copolymers are available in a variety of structures including, e.g., A-B-A triblock structures, A-B diblock structures, (A-B).sub.n radial block copolymer structures, and branched and functional versions thereof, wherein the A endblock is a non-elastomeric polymer block that includes, e.g., polystyrene, vinyl or a combination thereof, and the B block is an unsaturated conjugated diene or hydrogenated version thereof. Examples of suitable B blocks include isoprene, butadiene, ethylene/butylene (hydrogenated butadiene), ethylene/propylene (hydrogenated isoprene) and combinations thereof.

In certain embodiments, the pressure sensitive adhesive is a hot melt pressure sensitive adhesive that includes a styrene-isoprene-styrene block copolymer, Useful commercially available styrene-isoprene-styrene block copolymers include KRATON D1111 and KRATON D1119 available from Kraton Polymers U.S. LLC (Houston, Tex.).

The pressure-sensitive adhesive may further contain other components in addition to the base polymer. Examples of such other components include crosslinking agents such as polyisocyanates and alkyl-etherified melamine compounds; tackifiers such as rosin derivative resins (e.g. wood rosin, tall oil, gum rosin, and rosins esters), natural and synthetic polyterpene resins and derivatives thereof, petroleum resins e.g, aliphatic, aromatic and mixed aliphatic aromatic), hydrocarbon resins (e.g. alph methyl styrene resins, branched and unbranched C5 resins, C9 resins, C10 resins as well as styrenic and hydrogenated modifications of such, and oil-soluble phenol resins; plasticizers (e.g. liquid or solid plasticizers including e.g. hydrocarbon oils, polybutene, liquid tackifying resins, liquid elastomers and benzoate plasticizers); fillers; age inhibitors; and other suitable additives. Independently, the pressure-sensitive adhesive may further contain glass beads or resin beads. The addition of such glass or resin beads may facilitate the control of pressure-sensitive adhesive properties and shear moduli.

The thicknesses can range between 30 μm to 250 μm, preferably between 60 μm and 150 μm, and most preferably between 76 μm and 127 μm. For paperboard or corrugated, the opening tape width can range between 4 mm to 50 mm, preferably between 6 mm and 25 mm, and most preferably between 11 mm and 19 mm For bag closing and opening, the tape width can range between 4 mm to 100 mm, preferably between 24 mm and 76 mm, and most preferably between 30 mm and 55 mm.

The tape 20, 25, 50, and 80 may be provided in the form of a roll 11 as shown, for example, in FIGS. 3 and 4. In the embodiment shown in FIG. 3 the tape 20, 25, 50, and 80 is wound upon itself in an arrangement in which an outer length of tape 20, 25, 50, and 80 is aligned at an angle, particularly an acute angle, relative to an inner length of tape 20, 25, 50, and 80 upon which the outer length is disposed. In other words, each successive wind of the tape 20, 25, 50, and 80 traverses the previous, or underlying, tape 20, 25, 50, and 80 wind at an angle, particularly an acute angle. The FIG. 3 embodiment is an example of a “traverse wound roll.” In the embodiment shown in FIG. 4 the tape 20, 25, 50, and 80 is would upon itself so that each successive wind of the tape 20, 25, 50, and 80 is aligned parallel to the previous, or underlying, tape 20, 25, 50, and 80 wind. The FIG. 4 embodiment is an example of a “pancake wound roll.” When the tape 20 and 50 is in the form of roll, the adhesive layer 21 of a first length of the tape contacts the third surface 28 of a second length of tape overlaying the first length of the tape. When the tape 25 is in the form of roll, the adhesive layer 29 of a first length of the tape contacts the adhesive layer of 30 of a second length of tape overlaying the first length of the tape. When the tape 80 is in the form of roll, the adhesive layer 29 of a first length of the tape contacts the top surface of paper or film layer of 82 of a second length of tape overlaying the first length of the tape.

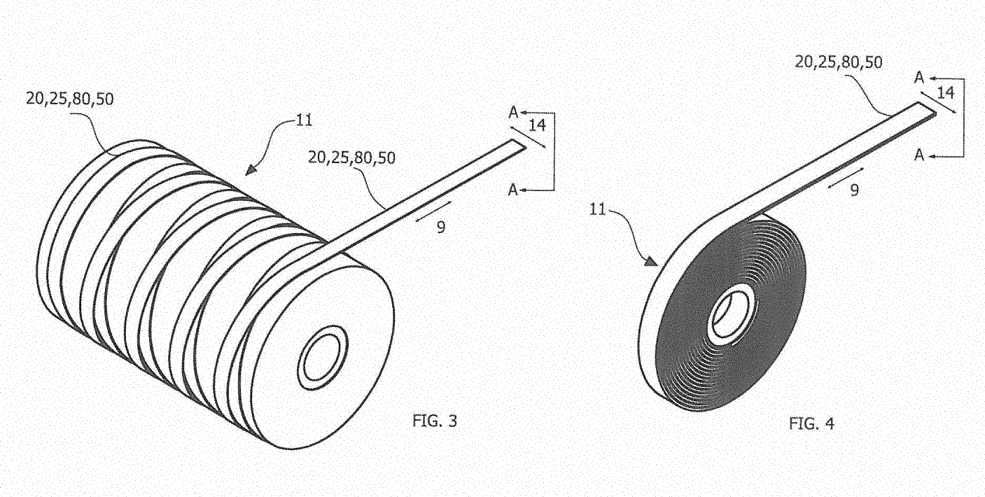

A preferred embodiment of the tear tape 25 disclosed herein is shown in FIG. 2. The tear tape 25 includes two adhesive (i.e. hot melt adhesive) layers 29 and 30 and a directional tear film layer 26. The tear tape has first surface 31 shared by the adhesive 29 and film layer 26, a second surface 32 shared by the adhesive 30 and film layer 26, a third surface 33 defining the outer surface of the adhesive layer 29, and a fourth surface 34 defining the outer surface of the adhesive layer 30. The adhesives 29 and 30 may be a layers that covers all, or only a portion thereof, of the area of the third surface 33 and fourth surface 34 respectively. The film has both weft strength and the property to tear in the longitudinal direction 9 of the tape 25. In the embodiment of FIG. 2 the film layer 26 provides weft strength to the tape and provides a smooth surface for the adhesive layers 29 and 30 to bond to,

The tear tape may be applied to any type of paper based substrate. In certain embodiment, the substrate may be a corrugated paper board. The corrugated board substrate includes an exterior liner and a corrugated member. In some implementations, the corrugated member consists of a series of parallel flutes. However, in other implementations, the corrugated member can include other configurations, such as a waffle-type pattern or honeycomb. The corrugated paper board may be a single wall structure includes a single fluted corrugated medium and at least one liner layer) or a multiwall structure (i.e., includes at least two fluted corrugated mediums and at least one liner layer). One or more substrates can form an article of manufacture such as a packaging container. Examples of packaging containers include cartons and boxes, such as cartons for holding beverages for sale at the retail level (for instance, a hand-carry carton that holds six, 12 or 24 bottles or cans of a beverage), meat and produce bulk bins, wet-packed containers, reusable containers, rubber and chemical bulk bins, and heavy duty containers. A continuous corrugated board substrate can be manufactured by bonding the corrugated member o the exterior liner using an adhesive, and subjecting the exterior liner and corrugated member to heat.

The tear tape 20 may be used as a tear tape for opening an article, such as a container, made from a paper based substrate. The tear tape 20 is used in a one-tape opening systems. Tape opening systems can also provide reinforcement of a container substrate or a handhole while facilitating effective opening of the container.

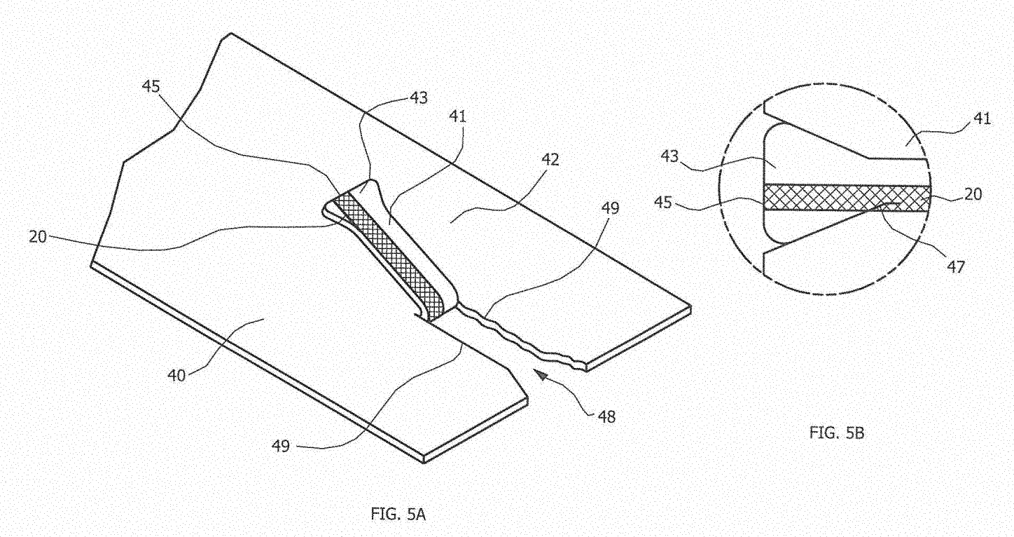

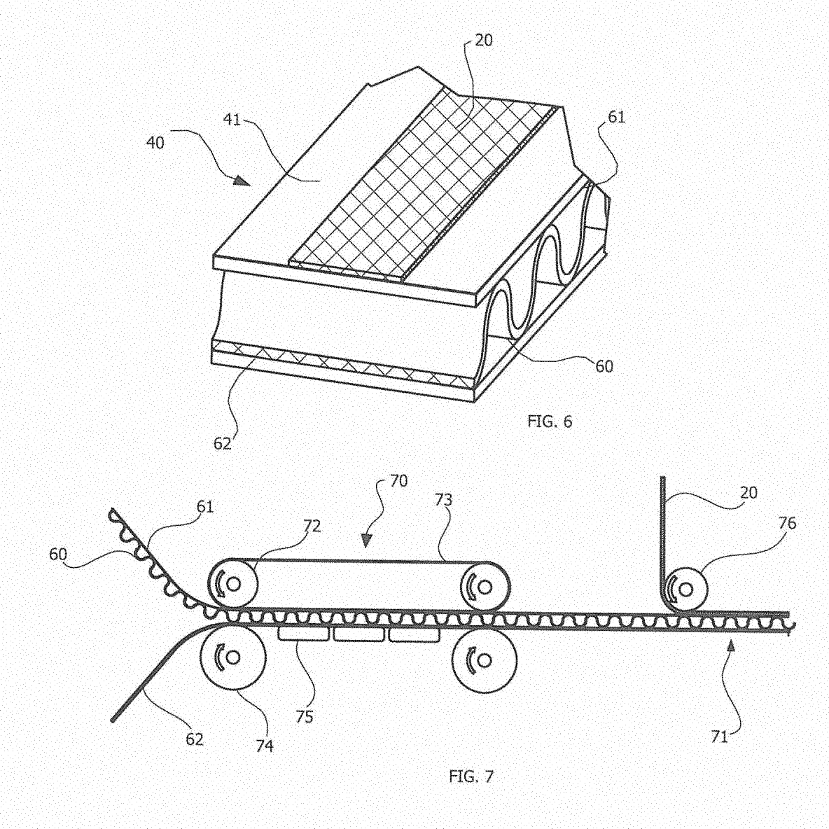

FIGS. 5A and 5B, show embodiments of a one-tape clean tear opening system. The tape 20 is adhesively secured to a first surface 41 of a paperboard substrate 40. The second tape surface of the tape 20 defined by the adhesive layer 21 contacts the first surface 41 of the paper based substrate 40 so that the tape 20 is adhesively secured to the paper based substrate 40. The paper based substrate 40 also includes a second surface 42 opposing the first surface 41. The tear tab 43 is formed in the paper based substrate 40. In certain embodiments the tear tab 43 has a flared handle portion at its tear-initiating end 45 that enables a user to grip and pull the tear tab 43. The tear-initiating end 45 of the tear tab 43 may be located at an edge of the paperboard substrate.

In certain embodiments the tear tab 43 may be made by cutting a profile or pattern that extends through the entire thickness of the paper based substrate 40 and that matches the profile of pattern of the tear tab 43. The cut 47 for the tear tab 43 is made during converting of the paper based substrate into a container from the paper based substrate. In the embodiments shown in FIGS. 5A and 5B the cut 47 also extends into a portion of the tape 20 to create the initiation of the clean tear.

The paper based substrate 40 with the tear tape 20 may be formed into a container. The first surface 41 of the paper based substrate 40 that carries the tape 20 forms the interior surface of the container, and the opposing second surface 42 of the paper based substrate 40 forms the exterior surface of the container. Because of the cut 47 extending through the entire thickness of the paper based substrate 40, a user can grip the tab 43 and pull on the tear tab 43 to open the container along desired tear line 49. For example, FIG. 5A shows a tear opening 48 forming in the paperboard substrate 40. The tear opening 48 can be extended a desired distance to open the container. For example, the tear tape 20 may be horizontally disposed around the peripheral circumference of the container thereby dividing the container into an upper and lower section.

A continuous corrugated board substrate that includes tape 20 may be made, for example, by the process shown in FIG. 7. FIG. 7 shows a corrugator having a wet end segment 70 and a dry end segment 71. Inside liner 61 adhered to the flutes of one side of the corrugated medium 60 is fed between pressure rolls 72 driving a pressure belt 73. An outside liner 62 is applied to the opposing flutes of corrugated medium 60 by being fed into the nip of roller 74. Thus, outside liner 62, corrugated medium 60, and inside liner 61 are sandwiched between pressure belt 73 and hot plates 75. Upstream from the rollers 72 and 74, an adhesive is applied to the flutes of the corrugated medium 60, which is heat activated so that when the three elements pass between pressure belt 73 and hot plates 75, the outside liner is firmly adhered to the corrugated member 60.

In the dry end segment 71 of the corrugator, tape 20 is applied to the outside surface of the inner liner 61. In the embodiment shown in FIG. 9, pressure is applied via a roller 76 so that the PSA surface of the tape 20 adheres to the outside surface of the inner liner 61. When paper based substrate 40 is formed into a container, the outside surface of the inner liner 61 becomes the interior surface of the container. Thus, tear tape 20 lies on the interior surface of the container.

The tear tape 20 disclosed herein also may be applied to a paper based substrate in a non-continuous manner. For example, the tape 20 may be applied intermittently at predetermined locations to the paper based substrate. In other words, a predetermined length of the tape 20 is applied at each location with a predetermined gap between the lengths of the tape 20.

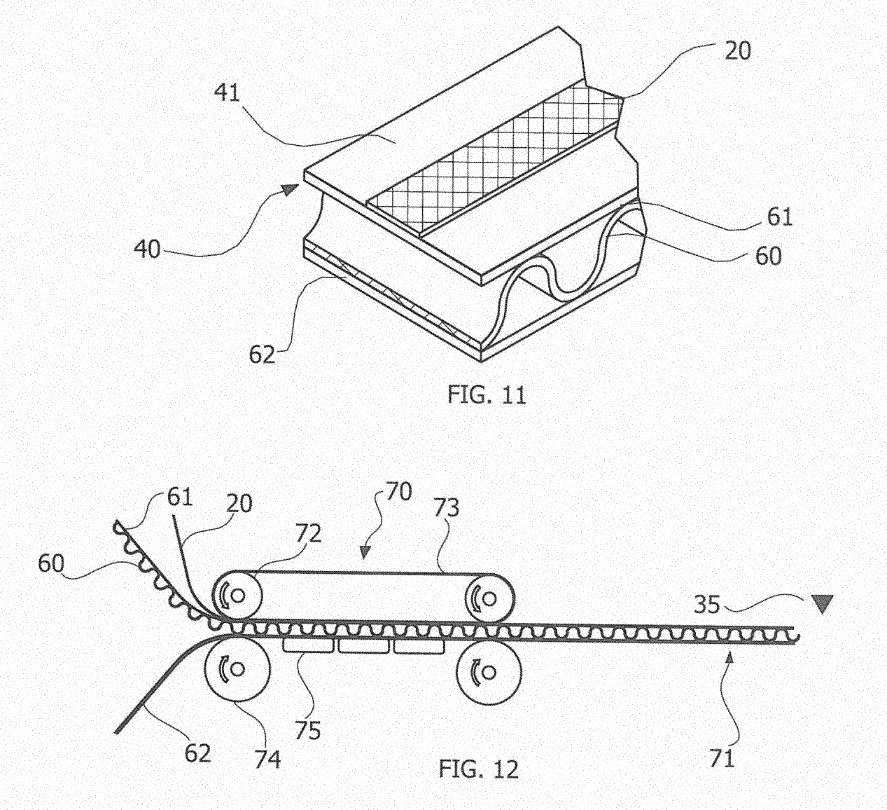

FIG. 11 shows an embodiment in which tape 20 is disposed on the first surface 41 of a paper based substrate 40. An adhesive side of tape 20 is adhesively secured to the first surface 41 of the paper based substrate 40. In this embodiment the paper based substrate 40 is a corrugated board substrate that includes a fluted or corrugated inner medium 60 disposed between inner liner 61 and outer liner 62.

A continuous corrugated board substrate that includes tape 20 may be made, for example, by the process shown in FIG. 12. FIG. 12 shows a corrugator having a hot plate and pressure segment 70, a cooling segment 71, and cut-off 35. The cut-off 35 may be a knife that cuts the corrugated board substrate into its desired length. Inside liner 61 adhered to the flutes of one side of the corrugated medium 60 is fed between pressure rolls 72 driving a pressure belt 73 In the hot plate and pressure segment 70 of the corrugator, tape 20 is applied to the outside surface of the inner liner 61. An outside liner 62 is applied to the opposing flutes of corrugated medium 60 by being fed into the nip of roller 74. Thus, the tape 20, outside liner 62, corrugated medium 60, and inside liner 61 are sandwiched between pressure belt 73 and hot plates 75. Upstream from the rollers 72 and 74, the appropriate tape adhesive section 21 on the tape 20 (and the adhesive applied to the flutes of the corrugated medium 60) is heat activated so that when the four elements pass between pressure belt 73 and hot plates 75, the outside liner is firmly adhered to the corrugated member 60 and the tape 20 is firmly secure to the inner liner 61. Activation of the adhesives on the tape takes place in the hot plate and pressure segment 70 at the corrugator processing temperature range. Setting of the adhesive takes place in the cooling segment 71 and prior to the cut off 31. In certain embodiments, the adhesive set time is equal to or less than the amount of time it takes for a given point on the tape 20 to move from the end of the hot plate/pressure segment 70 to the cut-off 35. In other words, the adhesive set time is equal to or less than the amount of time it takes for a given point on the tape 20 to travel from the exit of the hot plate and pressure segment 70 and prior to the cut off 35 (referred to herein as the corrugated board “dwell time”). For example, if the cooling segment of the corrugator is 50 meters long and the paperboard substrate is traveling at 300 meters per minute the dwell time calculates to be 10 seconds or 0.167 minutes. For the tape disclosed herein the set time of one of the adhesive sections needs to be less than the dwell time of the corrugators for the tape to firmly adhere to the paperboard substrate.

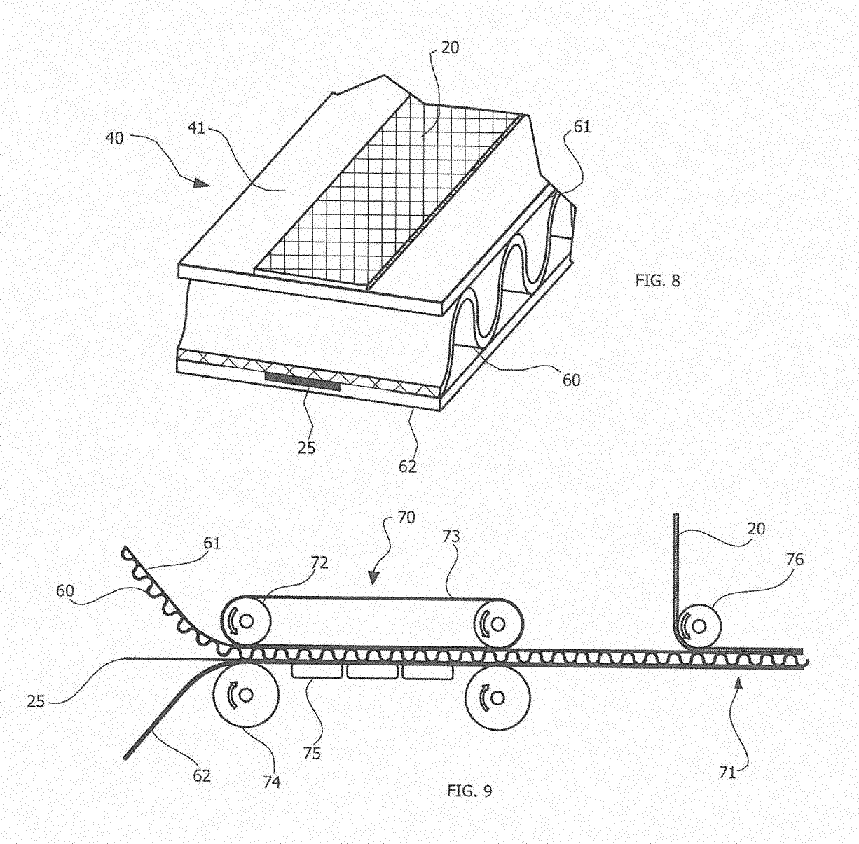

FIG. 8 shows embodiments of two-tape tear opening system on which one of the tapes is the PSA tape 20 disclosed herein. More specifically, PSA tape 20 is disposed on 41 of a paper based substrate 40. In this embodiment the paper based substrate is a corrugated board substrate that includes a fluted or corrugated inner medium 60 disposed between inner liner 61 and outer liner 62. A second tape 25 (FIG. 2) may be located between the outer liner 62 and the corrugated medium 60, or the second tape 25 may be located between the inner liner 61 and the corrugated medium 60. As described above, the paper based substrate 40 with the tear tape 20 and second tape 25 may be formed into a container. The first surface 41 of the paper based substrate 40 that carries the tape 20 forms the interior surface of the container, and the opposing second surface 42 of the paperboard substrate 40 forms the exterior surface of the container.

The second tape 25 is a guide tape that has both the property of weft strength and to tear in the longitudinal direction 9 of the tape 25. For example, the second tape 25 may be a hot met coated. The second tape 25 is aligned parallel to the PSA tape 20 and underlies (i.e., is juxtaposed with) the tape 20.

The second tape 25 is a guide tape that has both the property of weft strength and to tear in the longitudinal direction. These properties allows tearing of the guide tape along the tear lines while simultaneously maintaining the edge reinforcing there along. Thus, by grasping the tear tab 43 formed by the tear tab cut 47 and pulling the same in the longitudinal direction of the tear tape 20 and guide tape 25, tear tape 20 tears through the material of the paper based substrate 40 substantially coincident with tear tape 20 and also tears along guide tape 25 which guides the tear and provides edge reinforcement resulting in substantially even tear line 49. In certain embodiments, the tear tape 20 is employed as guide tape that may be located on the second surface 42 of the paper based substrate 40 rather than embedded within the paper based substrate. This, when the paper based substrate is formed into a container, the tape 20 is disposed on the exterior surface of the container.

Tape 20 is applied to the surface of the outside liner 62 by feeding it into the nip of the pressure roll 72 and roller 74 between outside liner 62 and corrugated medium 60 (see FIG. 9).

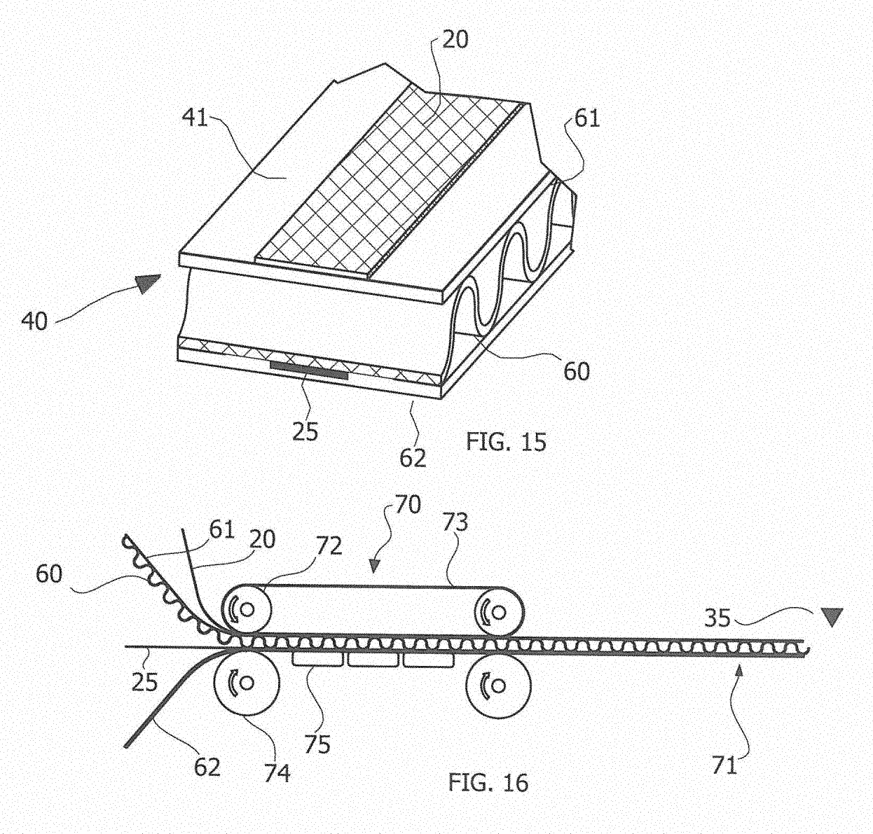

FIG. 15 shows an embodiment of a two-tape tear opening system in which one of the tapes is the tape 20 disclosed herein and the guide tape 25 is the second tape disclosed herein. More specifically, tape 20 is disposed on the first surface 41 of a paper based substrate 40. In this embodiment the paper based substrate is a corrugated board substrate that includes a fluted or corrugated inner medium 60 disposed between inner liner 61 and outer liner 62. A second tape 25 (guide tape), is disposed within the paper based substrate 40. The second tape 25 may be located between the outer liner 62 and the corrugated medium 60, or the second tape 25 may be located between the inner liner 61 and the corrugated medium 60. As described above, the paper based substrate 40 with the tear tape 20 and second tape 25 may be formed into a container. The first surface 41 of the paper based substrate 40 that carries the tape 20 forms the interior surface of the container, and the opposing second surface 42 of the paper based substrate 40 forms the exterior surface of the container. The second tape 25 is heat-activatable and set by the corrugating process as described above. The second tape 25 is aligned parallel to the tear tape 20 and underlies (i.e., is juxtaposed with) the tape 25. The tapes 20 and 25 can be sized to have the same or different widths. In certain embodiments, the second tape 25 is wider compared to tape 20. The second tape 25 is a guide tape that has good weft or cross machine direction strength. This weft strength in guide tape 25 together with property to tear in the longitudinal directing (machine direction) allows tearing of the guide tape along the tear lines while simultaneously maintaining edge reinforcing there along. Thus, by grasping tear tab 43 formed by tear tab cut 47 and pulling the same in the longitudinal direction of tear tape 20 and guide tape 25, tear tape 20 tears through the material of paper based substrate 40 substantially coincident with tear tape 20 and also tears along guide tape 25 which guides the tear and provides edge reinforcing resulting in substantially even tear lines 49.

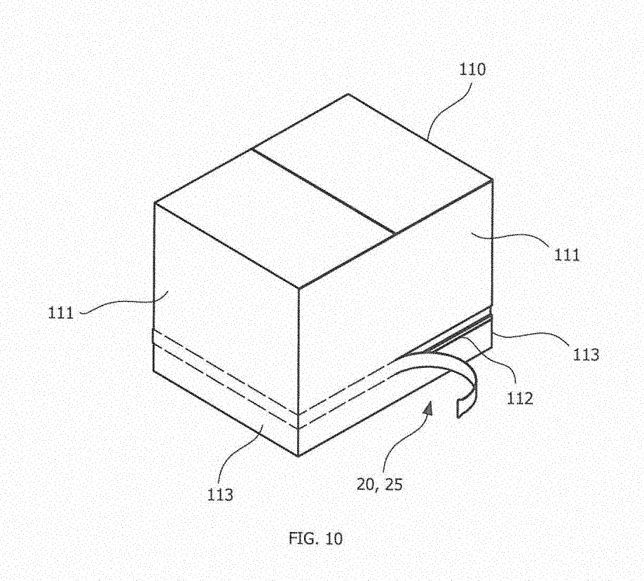

FIG. 10 shows a container 110 that includes a tear tape 20 or 20 and 25. Pulling on the tear tape 20 or 20 and 25 creates a tear opening 112 that divides the container 110 into a top section 111 and a bottom section 113.

Among other things, this disclosure describes embodiments of closures and opening systems for multi-wall and polywoven bags having non-sewn end closures with no holes through which contamination may enter the bag. In an example, a first end is closed by the manufacturer and is known as the manufacturers end. The bag with one end closed is sent to the consumer of the bags with one end open. After the consumer fills the bag, the second end is closed by the consumer.

The end closures can comprise a tape member applied to the bag at the open end to close it. The tape member can have an adhesive pre-applied to it, the tape can extends in a cross-bag direction across the entire or partial or past the width of the bag, and can then be pressed onto the bag to bond for PSA adhesive or heated to bond to the bag for hotmelt adhesive. The tape member adheres to the desired surfaces of the bag thereby closing the bag. The bag thus closed has no opening for entry of contamination. The tape member having the property to tear in the longitudinal direction (machine direction) also has the property to use this same tape to open the hag.

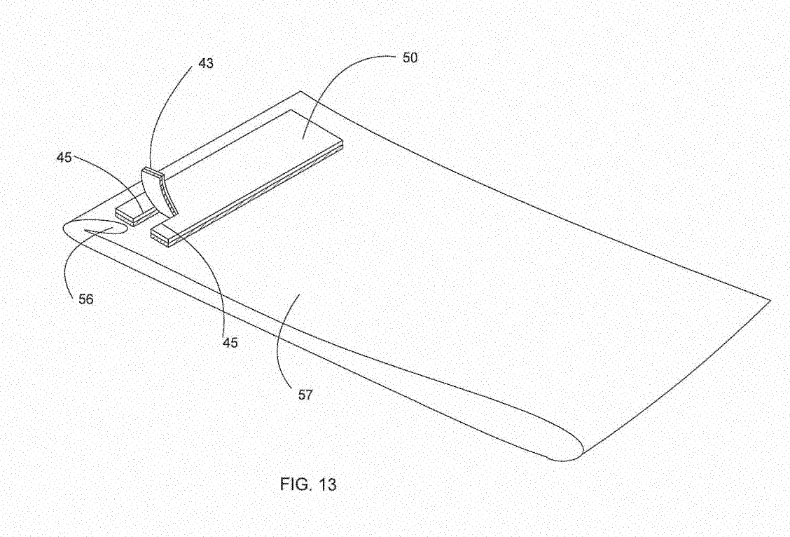

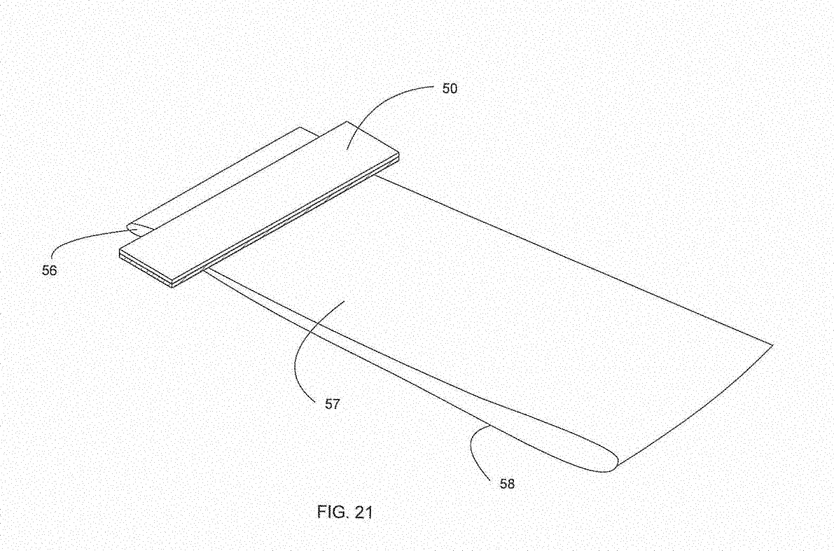

FIG. 13 shows an embodiment of an exemplary closing and opening tear system 50. More specifically, tape 50 is disposed on the bags closing flap 56 and bag first outside surface 57 to close the bag. The tape 50 has adhesive applied to the outside longitudinal edges with the center not having adhesive. The center has a tear tab 43 cut into it to be used to open the bag by the product end user (e.g., a consumer). This weft strength in tape 50 together with its property to tear in the longitudinal directing (machine direction) allows tearing of the tape along the tear lines while simultaneously maintaining closure reinforcement there along. Thus, by grasping tear tab 43 formed by tear tab cut 45 and pulling the same in the longitudinal direction of tape 50 the tape 50 tears separating the tape from the bag first outside surface 57 and bag closure flap 56 thereby opening the bag. The tape may extend beyond the edges of the bag as shown in FIG. 21 (note tear tab not shown in FIG. 21).

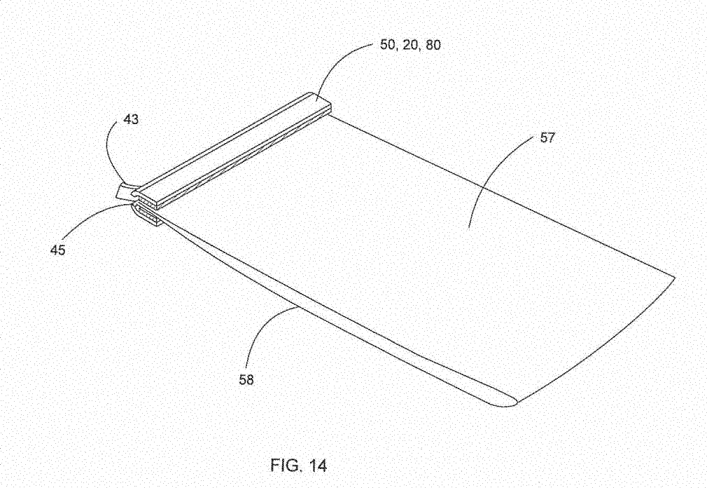

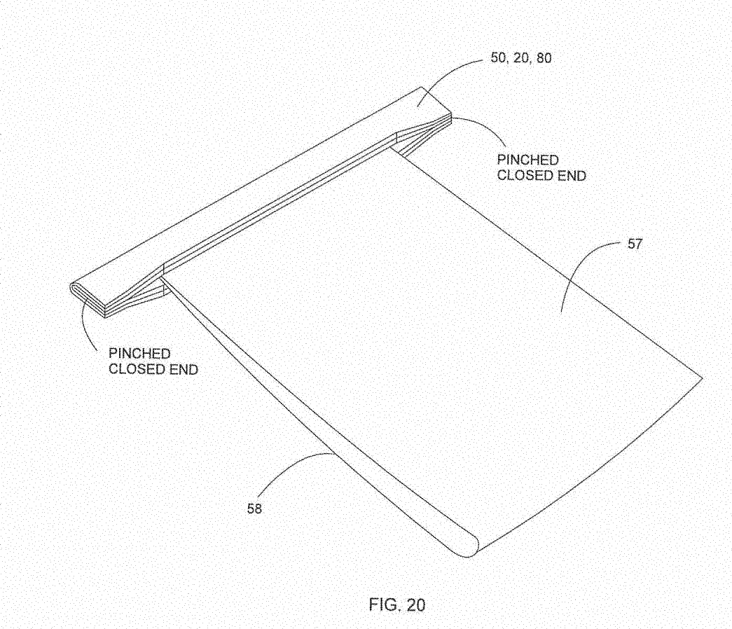

FIG. 14 shows an embodiment of a closing and opening tear system 50. More specifically, tape 20, 50, or 80 is disposed on the bag second outside surface 58 and bag first outside surface 57 to close the bag. The tape 50 has adhesive applied to the outside longitudinal edges with the center not having adhesive. The center has a tear tab 43 cut into it to be used to open the bag by the product end user. This weft strength in guide tape 50, 20, or 80 together with property to tear in the longitudinal directing (machine direction) allows tearing of the tape along the tear lines while simultaneously maintaining closure reinforcement there along. Thus, by grasping tear tab 43 formed by tear tab cut 45 and pulling the same in the longitudinal direction of tape 50 the tape 50 tears separating the tape from the bag first outside surface 57 and second outside surface 58 thereby opening the bag. The tape may extend beyond the edges of the bag as shown in FIG. 20 with tape ends pinched together (note tear tab not shown in FIG. 20).

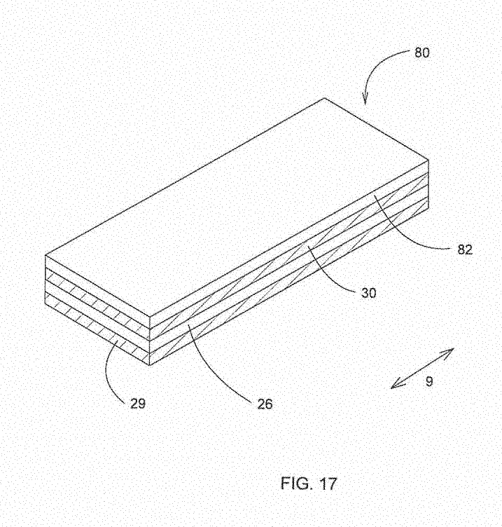

FIG. 17 shows a tape 80 with a second paper or film 82 laminated to the top of the monoaxially oriented film with directional tear. The second paper or film provides additional cross directional strength to tape to assure package survives drops and impacts.

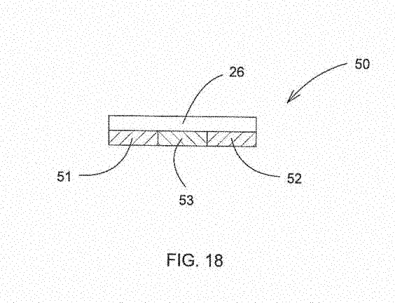

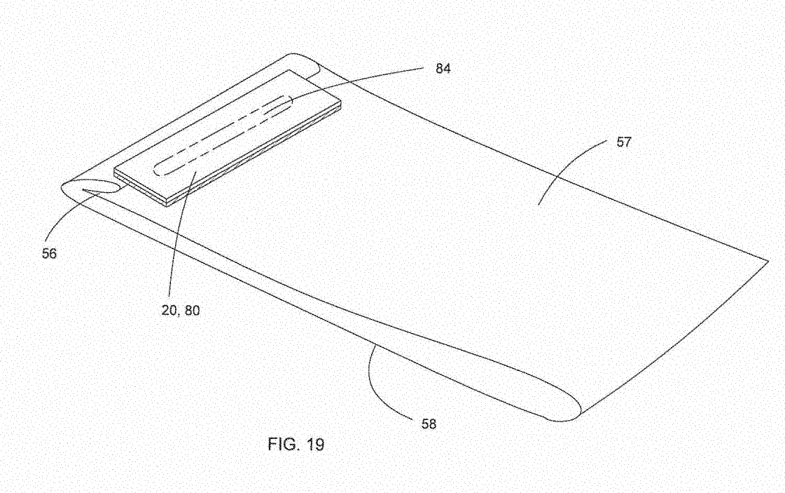

FIG. 18 shows a tape 50 with multiple adhesives striped on the closing side. Striping can include void areas. The outer stripes 51 and 52 would bond exceptionally well to the outer bag to create the sealing bond. The middle stripe 53 would have an adhesive with low peel strength to flow into the bag end to seal any exposed pin holes and prevent sifting.

FIG. 19 shows a bag sealed with the tape where the application method of pinching the bag shut has concentrated heat and or pressure to seal the areas around the gusset so no sifting occurs.

### EXAMPLES

The following examples are included to further illustrate various embodiments of the present disclosure only and therefore do not limit the scope of the present disclosure.

In a first example, tape 50 is applied by the consumer's bag closing process to a multi-wall bag FIG. 13 and FIG. 21. The gusseted multi-wall hag measures 35.5 cm wide and 58.5 cm tall and can contains 11.3 kilograms of animal feed. The closing and opening tape 50 is constructed from voided MOPP film coated with pressure sensitive hot melt adhesive on one side. The film product number is RS03 and available from Toray Plastics (America), Inc. The hot melt adhesive is product number HL2900 and available from HB Fuller, The adhesive is slot coated on the tape 50 at a thickness of 1 mil along the 20 mm outside longitudinal edges of the film. The film is 4 mil thick and 55 mm wide.

In a second example, tape 50 is applied by the consumer's bag closing process to a multi-wall bag FIG. 13 and FIG, 21. The gusseted multi-wall bag measures 35.5 cm wide and 58.5 cm tall and can contains 11.3 kilograms of pet food. The closing and opening tape 50 is constructed from cavitated MOPP film coated with hot melt adhesive on one side. The film product number is TF-CL4 and available from Toray Plastics (America), Inc. The hot melt adhesive is product number HM8255 and available HB Fuller. The adhesive is roll coated on the tape at a thickness of 1.5 mil along the 20 mm outside longitudinal edges of the film. The film is 3 mil thick and 55 mm wide.

In a third example, tape 20, 80, or 50 is applied by the bag manufacturer at the bag's first end to polywoven bag FIG. 14 and FIG. 20. The tubular polywoven bag measures 51 cm wide and 89 cm tall. The closing and opening tape is constructed from cavitated MOPP film coated with hot melt adhesive on one side. The film product number is TF-CL4 and available from Toray Plastics (America), Inc. The hot melt adhesive is product number HM8255 and available HB Fuller. The adhesive is roll coated on the tape at a thickness of 1.5 mil one side of the film. The film is 5 mil thick and 50 mm wide.

In a fourth example, tape 20, 50, or 80 is applied by the consumer's bag closing process to the polywoven bag FIG. 14 or FIG. 20. The tubular polywoven bag measures 51 cm wide and 89 cm tall and can contain 18 kilograms of powdered food product. The closing and opening tape is constructed from linear tear MOPP film coated with hot melt adhesive on one side. The film product number is TF-LF02 and available from Toray Plastics (America), Inc. The hot melt adhesive is product number NT20007 and available HB Fuller. The adhesive is roll coated on the tape at a thickness of 1.5 mil on one side of the film. The film is 4 mil thick and 50 mm wide.

In a fifth example, tape 20 is applied by the corrugator to the inside liner of the corrugated board to form a box blank. This box blank is then converted on a folder gluer into box 10. The box is single wall, B-flute, 32 ECT and measures 27.5 cm long, 18.7 cm wide and 20 cm tall. The opening tape is constructed from voided MOPP film coated with hot melt adhesive on one side. The film is product number is RS03 and available from Toray Plastics (America), Inc. The hot melt adhesive is product number BL20032 and available HB Fuller. The adhesive is roil coated on the tape at a thickness of 1 mil on one side of the tape. The film is 4 mil thick and 19 mm wide.

In a sixth example, tape 20 is applied to inside liner and tape 25 is applied between the median and outside liner by the corrugator to form a box blank The box blank is then converted on the folder gluer into box 10. The box is single wall, C-flute and measures 37 cm long, 27 cm wide and 25 cm tall. The tear tape 20 is constructed from cavitated MOPP film coated with hot melt adhesive on one side. The guide tape 25 is constructed from voided MOPP film coated with hot melt adhesive on both side. The tear tape film product number is TF-CL4 and the guide tape film is product number is RS03 and both available from Toray Plastics (America), Inc. The hot melt adhesive for the guide tape 25 and tear tape 20 are product number BL20032 and BL22515 respectively and both available from HB Fuller. On tape 20, the adhesive is roll coated on the tape at a thickness of 1 mil on one side of the tape. The film is 3 mil thick and 11 mm wide. On tape 25, the adhesive is roll coated on both sides of the tape at a thickness of 1 mil on each side the tape. The film is 3 mil thick and 15 mm wide.

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

As used herein, the terms “a”, “an”, and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A”, “B,”, “C”, “A and B”, “A and C”, “B and C”, or “A, B, and C.”

As used herein, the term “coupled” generally means physically (e.g., mechanically, chemically, adhesively, welded, etc.) coupled or linked and does not exclude the presence of intermediate elements between the coupled items absent specific contrary language.

In view of the many possible embodiments to which the principles of the disclosed technology may be applied, it should be recognized that the illustrated embodiments are only examples and should not be taken as limiting the scope of the disclosure. Rather, the scope of the disclosure is at least as broad as the following claims. We therefore claim as our invention all that comes within the scope of these claims.

1. A tear tape comprising:
a film layer having a first surface and an opposing second surface, a longitudinal direction along a length of the tear tape and a width direction perpendicular to the longitudinal direction, the film layer comprising a material that is configured to tear along the longitudinal direction of the film layer and resistant to tearing in the width direction of the film layer; and
an adhesive layer covering at least a portion of the first surface of the film layer;
wherein the tear tape is configured to be adhered to a packaging material via the adhesive layer such that:
a portion of the tear tape can be torn apart from another part of the tear tape along the longitudinal length of the tear tape to expose a longitudinal seam in the packaging material or create a longitudinal tear in the packaging material; or
at least a portion of the tear tape can be torn from the packaging material while producing a clean tear of the packaging material along the longitudinal direction of the tear tape white restricting tearing of the packaging material in the width direction of the tear tape.

2. The tear tape of claim 1, wherein the adhesive layer comprises pressure sensitive adhesive.

3. The tear tape of claim 1, wherein the adhesive layer comprises hot melt adhesive.

4. The tear tape of claim 1, wherein the tear tape is wound in the format of a traverse wound roll with the adhesive layer of one portion of the tear tape overlapping the second surface of the film layer of another longitudinally spaced portion of the tear tape.

5. The tear tape of claim 1, further comprising a second adhesive layer covering at least a portion of the second surface of the film layer.

6. The tear tape of claim 5, further comprising a second paper or film layer adhered to the second adhesive layer, such that the second adhesive layer is sandwiched between the two film layers.

7. A packaging material comprising:
the tear tape of claim 1; and
at least one layer of paper based substrate adhered to the adhesive layer, such that:
a portion of the tear tape can be torn apart from another part of the tear tape along the longitudinal length of the tear tape to expose a longitudinal seam in the paper based substrate or create a longitudinal tear in the paper based substrate; or
at least a portion of the tear tape can be torn from the paper based substrate while producing a clean tear of the paper based substrate along the longitudinal direction of the tear tape while restricting tearing of the paper based substrate in the width direction of the tear tape.

8. The packaging material of claim 7, wherein the tear tape includes two layers of adhesive, one on either side of the film layer, and wherein a first layer of paper based substrate is adhered to the first adhesive layer and a second layer of paper based substrate is adhered to the second adhesive layer.

9. The packaging material of claim 7, wherein at least one adhesive layer comprises two spaced apart adhesive strips with a non-adhesive region between the two spaced apart adhesive strips, and wherein the film layer is configured to tear such that a middle portion of the film layer overlapping the non-adhesive region tears apart from two lateral portions of the film layer adhered to the two spaced apart adhesive strips.

10. The packaging material of claim 9, wherein the middle portion of the film layer is torn free to expose an existing openable seam in the paper based substrate, while the two lateral portions of the film layer remain adhered to separable sections of the paper based substrate.

11. The packaging material of claim 9, wherein the tear tape is folded over the ends of two layers of paper based substrate, with one of the adhesive strips secured to an outer surface of one of the layers of paper based substrate and the other of the adhesive strips secured to an outer surface of the other layer of paper based substrate, and with middle portion of the film layer extending over free edges of the two layers of paper based substrate, such that tearing the middle portion of the film layer away exposes an opening between the two layers of paper based substrate.

12. The packaging material of claim 7, wherein the adhesive layer comprises three side-by-side longitudinally extending adhesive strips, including a middle adhesive strip and two lateral adhesive strips, and wherein the middle adhesive strip comprises an adhesive that is different relative to adhesives of the two lateral adhesive strips.

13. The packaging material of claim 7, wherein the adhesive layer comprises three side-by-side longitudinally extending adhesive strips, including a middle non-adhesive strip and two lateral adhesive strips.

14. The packaging material of claim 7, wherein the packaging material comprises a corrugated layer of paper based substrate, and wherein the tear tape is adhered to or imbedded in the corrugated layer.

15. A method of manufacturing a packaging material, comprising:
forming a tear tape by applying an adhesive layer to a film layer, the film layer comprising a material that is configured to tear along the longitudinal direction of the film layer and resistant to tearing in the width direction of the film layer; and
forming a packaging material by combining the tear tape with one or more layers of paper based substrate at an intended opening or tearing location, such that a longitudinal tear is formable in the tear tape and/or in the packaging material under the tear tape When at least a portion of the tear tape is torn free from the packaging material.

16. The method of claim 15, wherein combining the tear tape with one or more layers of paper based substrate comprises applying an adhesive side of the tear tape to a location that overlaps a seam between two adjacent sheets of paper based substrate, such that tearing a portion of the tape away frees the two sheets to separate apart.

17. The method of claim 15, wherein combining the tear tape with one or more layers of paper based substrate comprises applying an adhesive side of the tear tape to a single sheet of paper based substrate, such that tearing at least a portion of the tape away from the single sheet cleanly tears a longitudinal strip from the paper based substrate, at least on one side of the longitudinal strip.

18. The method of claim 15, wherein combining the tear tape with one or more layers of paper based substrate comprises applying the tear tape to a corrugated layer of paper based substrate.

19. The method of claim 15, wherein combining the tear tape with one or more layers of paper based substrate comprises folding the tear tape over two free edges of two sheets of paper based substrate such that the adhesive side of the tear tape adheres to outer surfaces of both sheets of paper based substrate.

20. The method of claim 15, further comprising tearing at least a portion of the tear tape away from the packaging material to produce a longitudinal tear in the tear tape and/or in the paper based substrate underlying the tear tape.
